(19) United States
(12) Patent Application Publication
(10) Pub. No.: US 2014/0278348 A1
(43) Pub. Date: Sep. 18, 2014

(54) SYSTEM FOR INTERSPECIES COMMUNICATIONS

(71) Applicant: A. Christian Tahan, Cambridge, MA (US)

(72) Inventor: A. Christian Tahan, Cambridge, MA (US)

(21) Appl. No.: 13/844,690

(22) Filed: Mar. 15, 2013

(51) Int. Cl. G06F 17/28

(52) U.S. Cl. CPC G06F 17/28
USPC 704/7; 704/2

(57) ABSTRACT

A system permitting communications between different organisms or species is disclosed.

### RELATED APPLICATIONS

This application claims the benefit of Provisional Application No. 61/694,780, filed Aug. 30, 2012.

### FIELD OF THE INVENTION

This invention relates to a system of communications, specifically allowing organisms that communicate with different languages, sounds, or behaviors to be understood by species that do not typically understand the unusual or foreign manners of communications.

### BACKGROUND OF THE INVENTION

Communications among humans is particularly difficult between speakers of different languages. However, translations can be made to allow for understandings. The solution of translation is ineffective when trying to understand the communications of a different species, e.g. a cat. Occasionally the species or member of a species will simply appear and be quiet and the human is left to wonder what the species member desires. Also, when the member of a species makes his or her distinctive sound, in one embodiment a meow, the human can only guess what the species member desires.

Speaking to different species has involved hand signals or commands that the species learns to recognize and react accordingly. Still, often an animal cannot communicate his or her thoughts to, in one embodiment, a human, who has to guess what the species member might desire. The guessing can be time consuming and frustrating particularly when the human is busy or e.g. rather not take the species member outside if the organism simply wants water or a food treat or snack.

What is presented is a means for interspecies communications that involves a system that allows for direct communications between organisms that have different means of expressing desires or needs, e.g. different sounds or behaviors. The system is to eliminate frustrations and miscommunications among species that could lead to inconvenience, time loss, and possibly needless expenses. The system allows for multi-way communications, in one embodiment between a cow and human and vice versa, including between non-humans, in one embodiment between a cat and dog and vice versa. The use of the system for communications between non-humans would involve both organisms knowing the commands or symbols on the communications platform to allow for understanding of what is desired by the communicating species.

### SUMMARY OF THE INVENTION

The invention or platform for communications involves, in one embodiment, one species learning the commands of the other species so that the species wishing to communicate can use the commands represented with symbols or pictures on the platform to express his or her needs or desires to be understood by the other species or organism. The platform, in one embodiment, could contain a library database of words and video or audio files since it can have a camera and microphone for recording body positioning or behavior and sounds that a species may use to communicate that the platform will translate to a word or sound that the other species will understand. The platform, in one embodiment, can contain pictures or symbols that the species wishing to communicate has learned from the other species or by independent learning. And the species wishing to communicate will recognize the symbols, in one embodiment, by the sounds or words the symbols present when touched or pressed. Thus, the platform serves as a mutual language since as with any language, symbols or words have to be learned. The invention is needed for communications since while certain species, in one embodiment humans, can teach other species to understand certain commands, the other species may not have a means for understandable expression.

Certain sounds or body movements or postures from an organism may be eventually learned by a species to have certain meanings so that when the organism makes the sound or body movement, the other species will respond accordingly. However, often an organism will have needs without making a sound or body movement, as by simply appearing before the other species as a human, who has to guess what the organism desires. The invention would allow for the organism to inform the other species what is desired by, in one embodiment, pressing a symbol on the invention platform. Also, the invention can allow for conversations between organisms. For instance, a human may wish to have a sensible conversation with his or her dog. Humans presently understand sounds or body positioning that a dog will make and will react accordingly. Yet, no system exists allowing for a manner of two way communications between the different species. Boards with symbols have been developed for communications between species. But the boards have not been customizable for use by different organisms; the boards have been for use by only one non-human species. The invention allows for an organism, in one embodiment a human, to record specific commands and to change symbols on the platform to be associated as the commands for the specific organism. Also, the invention is customizable related to what species use the platform for communications. In one embodiment, the platform can be for human and cow communications. The platform could also be used for communications between the same human and a different organism, in one embodiment a cat.

The ability to use the platform for multiple species is achieved with use of the species libraries/databases, in the platform and through the Internet or a different networking means. In other words, in one embodiment the platforms (the invention) can be networked to have access to multiple sound and behavior libraries simultaneously to allow for customization for use by different species, which is far from obvious and would be useful since numerous environments involve multi-species interactions, e.g. on farms, at zoos, in veterinarian offices. For example, a human may visit a zoo and may bring the platform, which could translate the sounds of a monkey due to the networked capability of the invention. Thus, though the invention is presented as an analog system in the drawings, the invention can be digital, as on a computer: desktop, laptop, mobile phone, or any electronic device.

On a farm, a farmer may have no idea what is wrong with one of his animals, particularly after a veterinarian examination showed that the organism is not ill or injured. Therefore, the farmer can use the platform to communicate with the organism by recording its body positioning, particularly if the positioning has never been seen before, or sounds. The ability to understand the organism will be improved and more possible through the networked capability of the platform (the invention). For instance, the organism may make a sound that the platform does not have in its library, but the sound may exist on a library in a different country that the platform can retrieve, in one embodiment since the platform will connect to databases worldwide with searching algorithms that will match the sounds and return words that the farmer can understand. If the word is in a different human language than what the farmer will understand since the organism sound was found in a database in a foreign country, the platform can translate the human sound by being networked. In other words, the platform in one embodiment can translate words, sounds, or behaviors between members of the same species, including between genders of the species if one gender may not understand what the opposite gender means. Or a body positioning or sound may be specific to the gender of an organism so that, in one embodiment, the farmer could specify part of the library search parameter to be the gender of the organism with which he or she wishes to communicate or understand. Accordingly, the library in the platform will take in account tone and inflections so that what is presented to the species member may be several choices in terms of what the member of the same species, in one embodiment though a different gender, or different organism may desire. Based on the situation or environment the species can choose which translation is most likely. Thus, this invention can be used by the same species, in one embodiment humans, to understand what opposite genders may desire.

The symbols on the platform can, in one embodiment, involve sounds related to the symbols or pictures so that the act of touching a picture can cause a sound or desire to be heard. The platform can be customizable so that symbols or pictures can be detached and different symbols or pictures can be attached to the area. Also, the sound for a symbol or picture can be recorded depending on the desire of the human. In other words, though the platform may present generic commands particularly if the invention is to be used for well-recognized relationships, in one embodiment between a dog and human, the platform can include symbols or commands that may be specific to a relationship. For example, a human may use a different word for going for a walk than the simple word, “walk,” which may be what is heard with the associated picture on the platform. Thus in one embodiment, the human can press a recording button under the position of the symbol or picture to use a microphone on the platform to record the word, phrase, or sentence that he or she uses to express walking or going for a walk.

The platform could also be used by the same species, in one embodiment, when a normal means to communicate may be absent. For instance, a human child or baby may press a symbol or picture to express his or her feelings to an adult human. Or a human with a disability may use the platform to express thoughts or words. Also, the camera capability could record the body, including facial expression, of the species, in one embodiment a human baby, to best indicate what the organism desires. In the example of a human baby, the apparatus can be extremely useful since often a parent may have no idea of what his or child desires, which can be frustrating particularly if the child may seem to be in discomfort. Thus, the platform could be informative, in one embodiment including medically informative, based on the recording of a sound or body positioning or movement, in one embodiment unusual limb or eye movement, particularly by using the customizable and networked species libraries and databases.

### BRIEF DESCRIPTION OF THE DRAWINGS

These and other features of the subject invention will be better understood in connection with the Detailed Description, in conjunction with the Drawings, of which:

FIG. 1 is diagrammatic illustration of the invention as a platform with pictures and symbols and a dog using the platform to communicate with different species and vice versa.

FIG. 2 illustrates the notion that voice or body positioning input of one species as a word, sound, or movement results in the output of a different species sound or word due to incorporation of a species library database.

FIG. 3 illustrates the networked capability of the platform, showing a connected system of database libraries allowing for input and output communications between species or organisms.

### DETAILED DESCRIPTION

Referring now to FIG. 1, the ability for interspecies communications to be achieved involves the invention (the platform 2) to contain symbols or pictures 6 that represent specific needs by the communicating species 4, which will press or touch the pictures 6 so that a different species 16 will understand his or her needs. The pictures 6 can be used by the different species 16 to communicate to the other species 4. Touching the pictures 6 can result in a word related to the picture 6 to be heard from the speaker 10 on the platform 2. The word associated with the picture 6 can be pre-programmed for specific species 4 or a different word or phrase can be recorded related to the pictures 6 by the other species 16 by using the recording button 12 under the pictures 6 and the microphone 14 for inputting the sound or word associated with the picture. The pictures 6, in one embodiment, are removable so that the platform 2 is customizable by a communicating species, e.g. the other species 16 receiving the communications. Also, the platform 2 can be used by multiple species by adjusting a dial 17 that can adjust the database library 22 that is pictured in FIG. 2. The letters D, C, and M on the dial 17 represent the communicating animal 4: in one embodiment dog (D), cat (C), monkey (M). An additional dial 17 can be incorporated on the platform 2 to represent the receiving species 16 so that, in one embodiment, the sound of the communicating species 4 will be understood by the other species 16. The platform 2 can also contain a camera 8 to record body positioning or movement of the communicating species 4 to express to the other species 16 through involvement of the species library/database 22 what is desired by the gesturing species 4.

The dial 17 is simply illustrative and can contain other letters to represent other animals. However, the dial is not a necessary component for the platform 2 to function and FIG. 1 can be thought the simplest presentation of the invention. In other words, with the networking capability of the platform 2, if in one embodiment a dog originally used the platform 2 but a cat suddenly appears and gestures or makes a sound that is pick-up by the microphone 14, the library database will search for the sound in other sound, word, or gesture databases globally. Still, the dial 17 can be most useful related to the receiving species 16 or 4 depending if the other species 16 communicates through the platform 2 with organism 4. For instance, though the library can find the input sound or gesture by the organism 4, the returned word or sound could be numerous. Thus, the dial 17 would allow the database to return the specific sound or word for the receiving species 16. The dial 17 would serve as an input parameter to the database to facilitate searches for specific words or sounds that would be understood. Therefore, a dial 17 for the communicating species 4 and a dial 17 for the other species 16 that can communicate with the organism 4 through the platform 2 improves functionality of the platform 2 in terms of spread and accuracy. Accordingly, the platform can contain additional dials 17, in one embodiment for country or gender considering that national origin or gender may influence meanings, to improve communications.

The customizability of the platform 2 can be further understood with the playback button 11. A sound or gesture may not be found in the networked databases so that a return or output word heard through speaker 10 would be, in one embodiment, “Unknown.” When the other species 16, in one embodiment a human, understands what the communicating species 4 desired, her or she can press the playback button 11 before pressing the recording button 12 to record a word or sound associated with the unrecognized sound, word, or gesture presented with the playback button 11 so that if the species 4 does the gesture or sound again, the platform 2 can provide the recorded word or sound. If the unrecognized communication was a gesture or body positioning, the pressing of the playback button 11 will simply allow for the recording of the gesture in the platform database 22 and on networked databases as the word or sound inputted by the other species 16 with use of the recording button 12. However the camera 8, in one embodiment, also can contain a screen for presenting the gesture to the other species 16 after the playback button 11 is pressed so that the other species 16 can again observe the body movement, positioning, or gesture to remember it better and possibly to have a better idea of how to express the movement with a word or sound by using the recording button 12. Use of the screen 8 can allow for presentation of a word in text, in one embodiment for a deaf human user 16, by using the networked species library database 22 for the translation so that the invention is, in one embodiment, an interspecies communications or speech to text system.

Though in the figures the invention is used by a dog, the invention is to be used by any species. In one embodiment, specific platforms 2 for specific species can exist with a species library/database 22 for the specific species or organism.

Referring now to FIG. 2, the platform 2 is shown to have a species library/database 22 that is responsible for the communications primarily to the other species 16. In other words, through the library/database 22 the organism 4 can communicate with the other species 16 by inputting a sound 18 to the microphone 14 to be heard as the other species 16 word or phrase 20. The library/database 22 is also shown to be responsible for the communication of a body gesture or movement through the use of the camera 8 to allow for an understandable word or phrase 26 for the other species 16. The library/database 22 is shown to be networked by having connectivity to a local area network (LAN) or wide area network (WAN), i.e. the Internet/database or databases 24.

In FIG. 2, as mentioned when describing FIG. 1 the connection to the Internet/database 24 is in case the word or sound 18 from the species 4 is not contained in the species library/database 22 on the platform. Thus, the library/database 22 after performing a search and not finding the sound or word 18 will start a search via a wireless or wired connection to the LAN or WAN or simply a species database away from the platform database. The presentation of the platform to contain the library/database 22 is one embodiment. The invention need not contain a self-contained library/database 22 and can simply be a networked platform that uses Internet/databases 24 for the communications between species 4 and 16. Primarily the library/database 22 can be thought the controlling center, in one embodiment containing memory cards or being a memory drive, of the platform to allow for the communications and relay of information, in one embodiment from the Internet/databases 24.

The library/database 22 of the platform 2 can be thought an accessible database in that it can be searched as part of the network of databases 28 in FIG. 3 to provide words or sounds. Multiple databases 28, as presented in FIG. 3, can be searched and when a translation is found, it is sent back to the platform 2 to be heard through the speaker 10. If a translation is not found, as mentioned previously the platform can indicate the word, “Unknown,” from the library/database 22 if the platform is for the other species 16 to be humans to understand the organism 4. If the other species 16 is non-human, the equivalent sound or word for, “Unknown,” may have been found in the networked databases 28 to be presented through the speaker 10. The “Unknown” equivalent could have been found with use of a dial 17 set to the setting, in one embodiment C, for the other species 16 on the platform. Accordingly as presented when describing FIG. 1, after the human understands what the species wanted, he or she can press the playback button 11 followed by the record button 12 to record the meaning of the sound in the platform database. If the species makes the sound again, the platform will provide the translation quickly, speed being one advantage to including a library/database 22 in the platform 2. Thus, the platform 2 can be scalable to include new sounds, words, or libraries directly from a human species or through automatic updates from other databases. For example, when the human records the meaning of the new sound with the button 12, after releasing the button 12 the new sound with the translation will be recorded to the platform 2 library/database 22 and will be communicated to other databases 24 so that other users of the system will have the sound available in case a species that is using their system platform 2 makes the noise. In other words, a different user of a platform 2 in a different location can encounter the same problem, but since the sound will be recorded on an accessible database 24, he or she will have the translation sent to his or her system and recorded automatically as an update. Or a periodic update to his or her platform 2 library/database 22 will have occurred so that when the organism 4 makes the noise or gesture, the platform 2 can provide the translation.

The presentation of FIG. 2 allows for the FIG. 1 system to be greater understood as either an analog or digital system. FIG. 1 presented the platform more as a self-contained system. FIG. 2 presents the platform more as a networked system, which allows for the system to be useful, in one embodiment, on portable devices as mobile phones, laptops, or electronic handheld devices including smart phones, tablets, etc. The usefulness of the platform can be for humans that work with animals, e.g. farmers or veterinarians, or for the amusement of users that interact with animals, e.g. visitors to the zoo. Also, the system can serve to allow species to avoid harm. For instance, one imagined scenario for use of the system can be if a human suddenly encounters an animal that the human does not recognize, in one embodiment a dog since dogs can be friendly or dangerous. If the dog starts running and barking toward the human, the human could prepare to defend himself or herself, potentially injuring the dog, or through use of the system realize that the dog is approaching the human to have his or her belly scratched. In other words, an aggressive action can be misinterpreted without the platform, but since the human has the platform on, in one embodiment, his or her mobile phone or smart phone he or she could avoid hurting the dog or being in fear since the human will understand to scratch the belly of the dog when he or she reaches the human. The dog example actually was witnessed with the human striking the dog with a large stick before realizing that the seemingly aggressive dog simply wanted to greet the human playfully.

Since species communicate with body movement or positioning, the camera 8 can record a movement by the species and send the image to the species library/database 22 to be translated and presented in the language 26 of the receiving species 16. The voice that is heard out of the speaker 10 is the voice that was recorded for the species library/database 22. However, a human can record his or her voice related to sounds the species 4 is making by using the playback button 11 and the record button 12. Similarly the images 6 have prerecorded names or sounds in the species library/database 22. A human wishing to change the associated sound can use the record button 12 to record, in one embodiment, his or her voice saying a word. The recording likely would be required if removing an image 6 and replacing it with a new image 6. Accordingly the symbols, images, or pictures 6 can be permanently attached or removable, in one embodiment, as due to being attached with an adhesive as Velcro.

Referring now to FIG. 3, the platform 2 is a networked system for interspecies communications. FIG. 3 illustrates the networked capability of the platform, showing a connected system of database libraries allowing for input and output communications between species. The FIG. 3 connectivity should not be thought to be useful only for vocalizations from the organism 4, but the networked system allows additionally for body movements, gestures, and posturing to be searched and translated 26, in one embodiment a gesture representing an emotion that is translated to an audible word for the receiving species 16.

In one embodiment, multiple platforms used by numerous users in different locations globally could add to the networked databases 28, apart from the databases containing preprogrammed sounds, gestures, or words that may be commonly recognized from various species. The regional databases 28 are a global distribution of databases, shown to inter-communicate to find the translation of sounds or gestures from the communicating species 4. The inter-communications between the databases 28 is also shown for local databases 30 that can communicate found information to the regional databases 28 that can, in one embodiment, relay the translation to the Internet/database connection 24 of the platform 2. The relaying would allow for updating of the regional databases with any information found in a local database 30 or in a regional database 28.

Because of the networked capabilities of the system, a species could communicate with a different species remotely. For example, a platform 2 in Texas could be in a location, in one embodiment attached to a wall, in the room where the family pet typically lounges. In other words, platforms could be placed or attached to the most convenient locations for communications with the intended species. The pet could make sounds in the microphone 14 and the translation can be communicated to the platform on the mobile phone of the human owner of the pet that may be in Massachusetts. By that, the networked system allows for communications between platforms (the invention). The purpose for the pet to make sounds in the platform 2 in Texas could be to communicate to the owner that danger, e.g. an intruder, in the home exists. Accordingly, the owner hearing the word, in one embodiment “Danger,” through his platform on his mobile phone can contact the police in his home town to visit his home to investigate.

What is claimed is:

1. A system for interspecies communications, comprising the steps of:
assigning symbols or pictures that would be recognized to represent specific words, sounds, or needs by a different species or organism.

2. The method of claim 1, wherein the symbols or pictures are on a platform for easy access by a species.

3. The method of claim 2, wherein the platform is a means of display that can be mounted to surfaces.

4. The method of claim 2, wherein the platform is portable.

5. The method of claim 1, wherein the symbols or pictures are words or sounds that are used to represent inputted sounds or recorded body movements or posturing through a camera or microphone on the platform.

6. The method of claim 5, wherein the words or sounds are translations as part of a library database.

7. The method of claim 1, wherein the pictures or symbols are photographs or images of objects or needs.

8. The method of claim 1, wherein the pictures or symbols are images dissimilar in appearance to desired objects or needs used to represent the objects or needs.

9. The method of claim 1, wherein one species or organism uses the symbols or pictures to communicate with a different species or organism.

10. The method of claim 1, wherein sounds are assigned to the pictures or symbols.

11. The method of claim 1, wherein the symbols or pictures can be removed or replaced and can be assigned to represent different words, sounds, or needs.

12. The method of claim 1, wherein a means to record sounds related to the pictures or symbols exists.

13. The method of claim 1, wherein a microphone exists for a species or organism to input sounds or vocalizations.

14. The method of claim 1, wherein a library database is contained in the platform containing the pictures or symbols that contains the recorded sounds or words associated with the pictures or symbols.

15. The method of claim 1, wherein a library database in the platform is a translation library for sounds or vocalizations allowing for translation from the input of one species or organism to the output of a word or sound of a different species or organism.

16. The method of claim 1, wherein a speaker exists to hear sounds assigned to pictures or symbols or to hear the translations of sounds or vocalizations from species inputted through the microphone.

17. The method of claim 1, wherein a camera exists to record the body movements or posturing of a species with the camera containing or being part of a screen for observing the body movements or posturing.

18. The method of claim 1, wherein a library database in the platform has a translation library for body movement or posturing that is inputted with the camera to be outputted as a word or sound through the speaker for a different species to understand.

19. The method of claim 1, wherein a playback button exists to hear or view the sound or body posturing or movement input of species or organisms.

20. The method of claim 1, wherein dials can be set to make the platform for communications between specific organisms or species.

21. The method of claim 1, wherein dials can be set to distinguish between genders of different species or for communications between genders of the same species.

22. The method of claim 1, wherein the platform is wired or wirelessly connected to a LAN or WAN including an Ethernet or Internet for accessing databases away from the platform.

23. The method of claim 1, wherein the platform is networked to library databases at various locations thereby increasing the capability of the platform to translate inputs from organisms or species.

24. The method of claim 1, wherein the platform is networked thereby allowing it to be scaleable to a multi-species system due to the connections to various library databases.

25. The method of claim 1, wherein the platform is networked thereby allowing the internal library/database to be searchable and part of the network of databases.

26. The method of claim 1, wherein the internal library/database can be updated with new words, sounds, body movements, or posturing from the networked library databases automatically or periodically particularly when the networked databases are updated with new content.

27. The method of claim 1, wherein the platform is networked so that when an update to the internal library/database occurs, other databases including other internal library/databases are automatically or periodically updated with the new content.

28. The method of claim 1, wherein the internal library/database is updated when one species presses the record button to record sounds related to pictures or symbols or related to inputted sounds or body movements or posturing due to preference or since the networked databases may not have recognized the inputted body movement or sound so that no translation was originally provided.

29. The method of claim 1, wherein a platform can be used for communications among the same species or organism, particularly when the species use different languages or body movements or posturing that may be foreign to a member of the species.

30. The method of claim 1, wherein the system is an analog display that is networked.

31. The method of claim 1, wherein the system is networked to other platforms through a wired or wireless connection.

32. The method of claim 1, wherein the system is a digital display that is networked.

33. The method of claim 1, whereby inputted sounds or body movements and posturing are translated to words or sounds in complete sentences due to a library database filling in missing words to complete sentences with the inputted sound or body movement translations.

34. The method of claim 33, wherein the completed sentences permit conversations between species.

35. The method of claim 1, wherein systems can be in different locations for communications between species from different locations.

36. The method of claim 35, wherein the systems in different locations can be either analog or digital.

37. The method of claim 1, wherein the library database is at a database away from the platform or species interface.

38. The method of claim 1, wherein a library database in a platform is updated with new content from other networked databases at the discretion of a species using it.

39. The method of claim 1, wherein a device as a mobile phone or computer or any electronic device without the system is used to contact a platform in a different location to communicate with a species or organism.

40. The method of claim 39, wherein the input to the device is in the form of voice or sound communications.

41. The method of claim 39, wherein the input to the device is in the form of non-voice or sound communications as with the input of text.

42. The method of claim 41, wherein the text is converted to speech or vice versa by the platform receiving the communication.

43. The method of claim 2, wherein a platform contains multiple communication antennas or mediums to allow for different devices to communicate with it and for the platform to communicate with different devices.

44. The method of claim 1, wherein the system allows for the saving of communications or conversations on a platform or away from the platform in a network.

45. The method of claim 44, wherein transcripts of conversations can be provided including printed.

46. The method of claim 1, wherein the camera can monitor eye movement so that a symbol or picture can be activated with eye contact.

47. The method of claim 1, wherein memory can replace or be added to the system as through a specific insertion slot to upgrade the species library database or to allow the platform to be for specific species.
